(19) United States
(12) Patent Application Publication
(10) Pub. No.: US 2024/0281366 A1
(43) Pub. Date: Aug. 22, 2024

(54) PROCESSING CIRCUIT AND COMPUTATION SCHEDULING METHOD OF ARTIFICIAL INTELLIGENCE MODEL

(71) Applicant: SigmaStar Technology Ltd., Xiamen (CN)

(72) Inventor: Qing Yu, Shanghai (CN)

(21) Appl. No.: 18/537,849

(22) Filed: Dec. 13, 2023

(30) Foreign Application Priority Data
Feb. 21, 2023 (CN) 202310146042.5

(51) Int. Cl. G06F 12/02; G06F 9/48

(52) U.S. Cl. CPC G06F 12/0238; G06F 9/4881

(57) ABSTRACT

A processing circuit of an artificial intelligence (AI) model includes a memory, a memory management circuit, and an operation circuit. The memory management circuit reads a tensor from an external memory and stores the tensor in the memory. The operation circuit is configured to perform the following operations: performing an operation of a first type on a first and second sub-tensors of the tensor to generate a first and second intermediate data, respectively; performing an operation of a second type on the first intermediate data and the second intermediate data to generate a third intermediate data; performing an operation of the first type on a third sub-tensor of the tensor to generate a fourth intermediate data; and performing an operation of the second type on the first intermediate data, the second intermediate data, and the fourth intermediate data to generate a fifth intermediate data.

This application claims the benefit of China application Serial No. 202310146042.5, filed on Feb. 21, 2023, the subject matter of which is incorporated herein by reference.

### BACKGROUND OF THE INVENTION

### 1. Field of the Invention

The present invention generally relates to artificial intelligence (AI) models, and, more particularly, to the processing circuit and computation scheduling method of the AI models.

### 2. Description of Related Art

In a system on a chip (e.g., system-on-chip (SoC)), the total amount of memory bandwidth is often fixed and used by multiple modules. When a particular module takes up a significant amount of memory bandwidth, it prevents other modules from accessing the memory, resulting in decreased system performance. As a module in the system on a chip, the artificial intelligence (AI) model often needs to process a large amount of data and requires a large memory bandwidth. Therefore, reducing the bandwidth requirements of AI models has become an important issue.

### SUMMARY OF THE INVENTION

In view of the issues of the prior art, an object of the present invention is to provide a processing circuit and a computation scheduling method for an artificial intelligence (AI) model, so as to make an improvement to the prior art.

According to one aspect of the present invention, a processing circuit for an AI model is provided. The processing circuit is coupled to an external memory and includes a memory, a memory management circuit, and an operation circuit. The memory management circuit is configured to read a tensor from the external memory and store the tensor in the memory. The operation circuit is configured to perform an operation of a first type on a first sub-tensor of the tensor to generate a first intermediate data, perform the operation of the first type on a second sub-tensor of the tensor to generate a second intermediate data, perform an operation of a second type on the first intermediate data and the second intermediate data to generate a third intermediate data, perform the operation of the first type on a third sub-tensor of the tensor to generate a fourth intermediate data, and perform the operation of the second type on the first intermediate data, the second intermediate data, and the fourth intermediate data to generate a fifth intermediate data.

According to another aspect of the present invention, a processing circuit for an AI model is provided. The processing circuit is coupled to an external memory, includes a memory, and performs following operations: reading a tensor and a plurality of kernel parameters from the external memory and storing the tensor and the kernel parameters in the memory, wherein the tensor includes a first sub-tensor and a second sub-tensor, and the kernel parameters include vector kernel parameters; performing a first vector operation on the first sub-tensor with reference to a first subset of the vector kernel parameters to generate a first intermediate data; and performing a second vector operation on the second sub-tensor with reference to a second subset of the vector kernel parameters to generate a second intermediate data. The first subset of the vector kernel parameters is different from the second subset of the vector kernel parameters.

According to still another aspect of the present invention, a computation scheduling method for an AI model that includes a first operator and a second operator is provided. The computation scheduling method including the following steps: splitting a tensor into H sub-tensors, wherein H is an integer greater than one; splitting the first operator into H first sub-operators; splitting the second operator into H second sub-operators; determining a dependency relationship among the H first sub-operators and the H second sub-operators; sorting the H first sub-operators and the H second sub-operators according to the dependency relationship to obtain an operation order; and determining, according to the operation order, when a processing circuit executing the AI model deletes a target data from a memory included in the processing circuit, the target data being an output data of one of the H first sub-operators and the H second sub-operators.

The technical means embodied in the embodiments of the present invention can solve at least one of the problems of the prior art. Therefore, compared to the prior art, the present invention can reduce memory usage and/or reduce memory bandwidth requirements.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 shows an example of an AI network.

FIG. 2 is a flowchart of a computation scheduling method for an AI model according to an embodiment of the present invention.

FIG. 3 is a result of splitting tensors and operators in FIG. 1.

FIG. 4 shows a topological graph of connections between sub-operators.

FIG. 5 is a detailed flowchart of step S230 in FIG. 2 according to an embodiment.

FIG. 6 shows a dependency relationship among multiple sub-operators.

FIG. 7 is a detailed flowchart of step S240 in FIG. 2 according to an embodiment.

FIG. 8A and FIG. 8B show schematic diagrams of a queue according to an embodiment of the present invention.

FIG. 9 is a functional block diagram of the electronic device according to an embodiment of the present invention.

FIG. 10 shows a schematic diagram of a life span list according to an embodiment of the present invention.

FIG. 11 shows a flowchart of allocating a memory.

FIG. 12A and FIG. 12B are schematic diagrams of an alive list according to an embodiment of the present invention.

FIG. 13 is a schematic diagram of another AI model.

FIG. 14 is a schematic diagram of another AI model.

FIG. 15A and FIG. 15B are flowcharts of the execution method of the AI model according to an embodiment of the present invention.

FIG. 16 is a schematic diagram of the stored contents of the buffer circuit and the memory according to an embodiment of the present invention.

FIG. 17 is a detailed flowchart of step S1510 or step S1520 in FIG. 15A.

FIG. 18 is a detailed flowchart of step S1530 in FIG. 15A.

FIG. 19 is a schematic diagram of the stored contents of the buffer circuit and the memory according to another embodiment of the present invention.

FIG. 20 is a detailed flowchart of step S1560 in FIG. 15B.

FIG. 21 is a functional block diagram of a memory management circuit according to an embodiment of the present invention.

FIG. 22 is a schematic diagram of a multi-stage pipeline according to the present invention.

FIG. 23 is a flowchart of multi-stage pipeline operation according to an embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a processing circuit and a computation scheduling method of an artificial intelligence (AI) model. On account of that some or all elements of the processing circuit of the AI model could be known, the detail of such elements is omitted provided that such detail has little to do with the features of this disclosure, and that this omission nowhere dissatisfies the specification and enablement requirements. A person having ordinary skill in the art can choose components or steps equivalent to those described in this specification to carry out the present invention, which means that the scope of this invention is not limited to the embodiments in the specification.

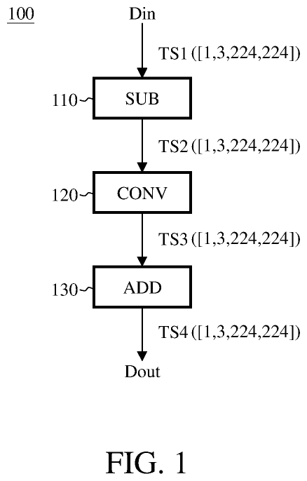

FIG. 1 is an example of an AI network which can be viewed as a simple AI model or as part of a complex AI model. The AI network 100 is used to compute the input data Din to generate the output data Dout. The AI network 100 of FIG. 1 includes three operators: a subtraction operator 110 (“SUB”), a convolution operator 120 (“CONV”), and an addition operator 130 (“ADD”). The subtraction operator 110 performs a subtraction operation on a tensor TS1 (i.e., the input data Din) to generate a tensor TS2. The convolution operator 120 performs a convolution operation on the tensor TS2 to generate a tensor TS3. The addition operator 130 performs an addition operation on the tensor TS3 to generate a tensor TS4 (i.e., the output data Dout). In the example in FIG. 1, the sizes (dimension information) of the tensor TS1, the tensor TS2, the tensor TS3, and the tensor TS4 are all [1,3,224,224].

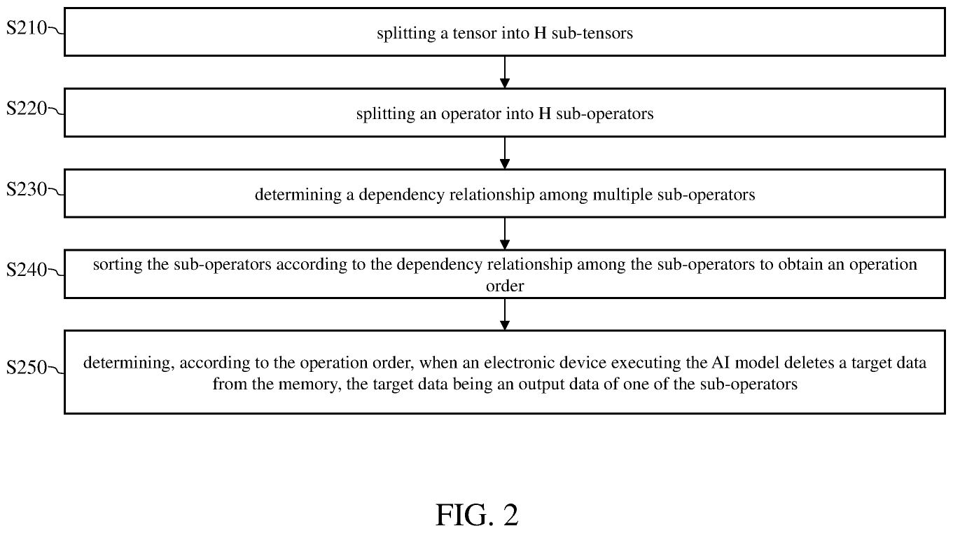

FIG. 2 is a flowchart of the computation scheduling method for the AI model according to an embodiment of the present invention. The flow of FIG. 2 is executed by a chip development tool (e.g., a computer) and includes the following steps.

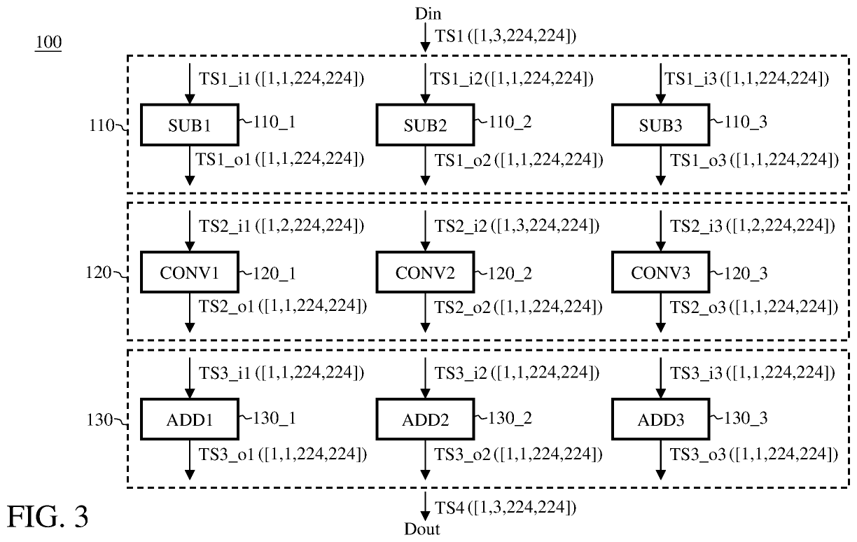

Step S210: Splitting the tensor into H sub-tensors (also referred to as tiles), where H may be any dimension of the tensor (H is an integer greater than 1). More specifically, this step determines the value of H according to one of the dimensions of the output tensor of the last operator of the AI network 100, and then splits the tensor into H sub-tensors. Taking the AI network 100 in FIG. 1 as an example, because the size of the output tensor (i.e., the tensor TS4) of the last operator (the addition operator 130) is [1,3,224,224], H may be 3 or 224. The details of splitting the tensors will be discussed below with reference to FIG. 3.

Step S220: Splitting the operator into H sub-operators. This step together with the step S210 will be discussed below with reference to FIG. 3.

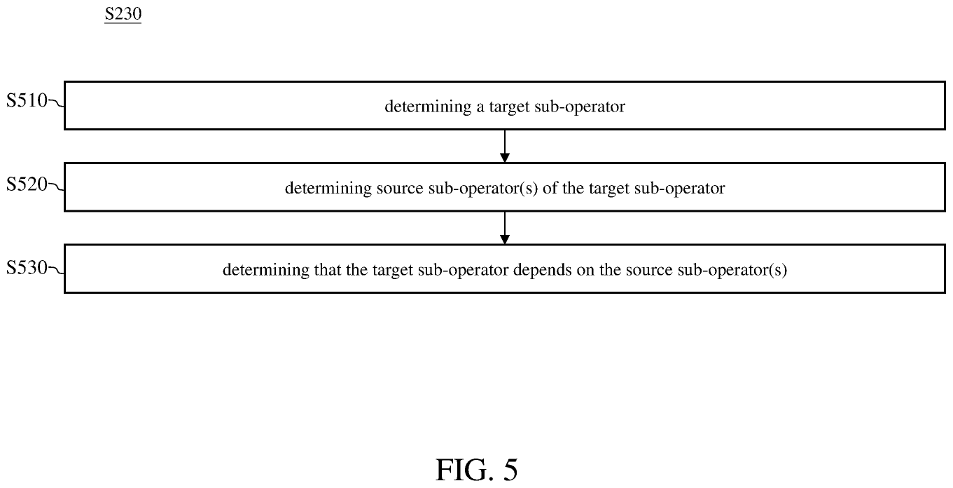

Step S230: Determining a dependency relationship among multiple sub-operators. This step will be discussed below with reference to FIG. 5.

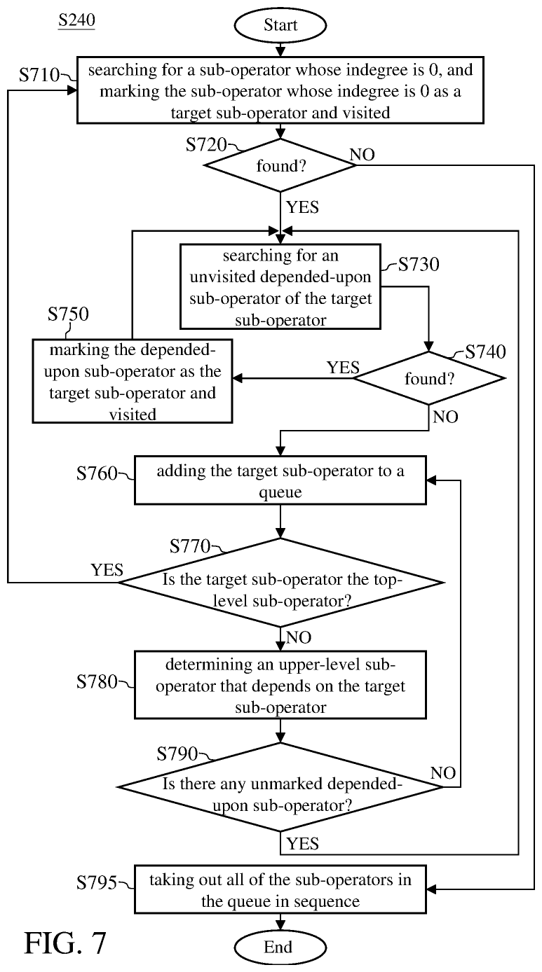

Step S240: Sorting the sub-operators according to the dependency relationship among the sub-operators to obtain an operation order. This step will be discussed below with reference to FIG. 7.

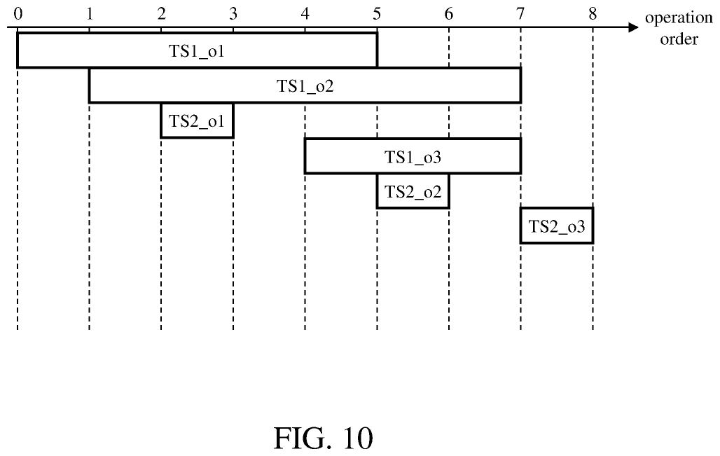

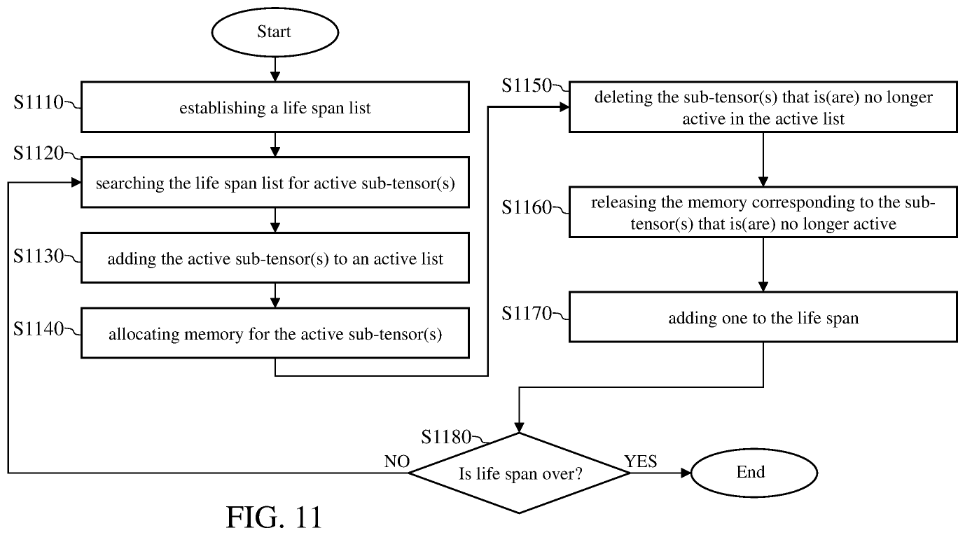

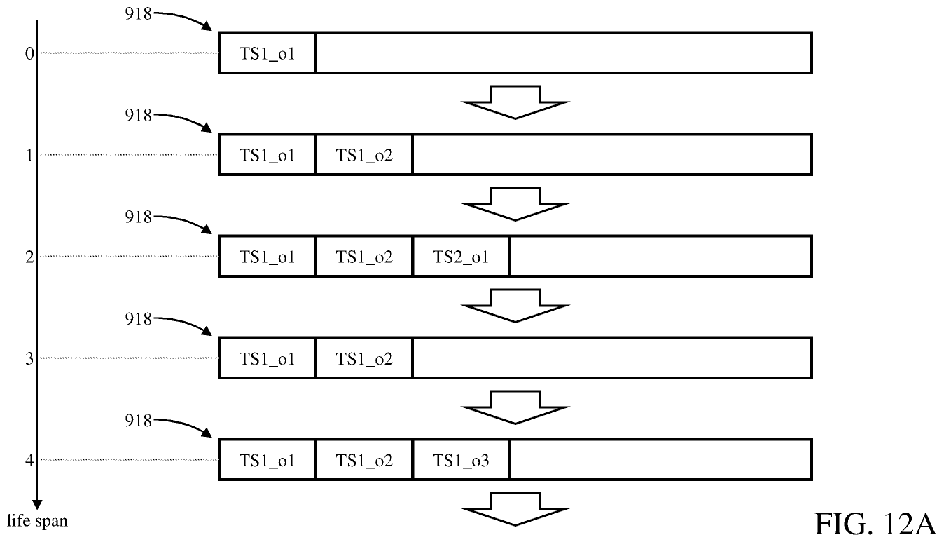

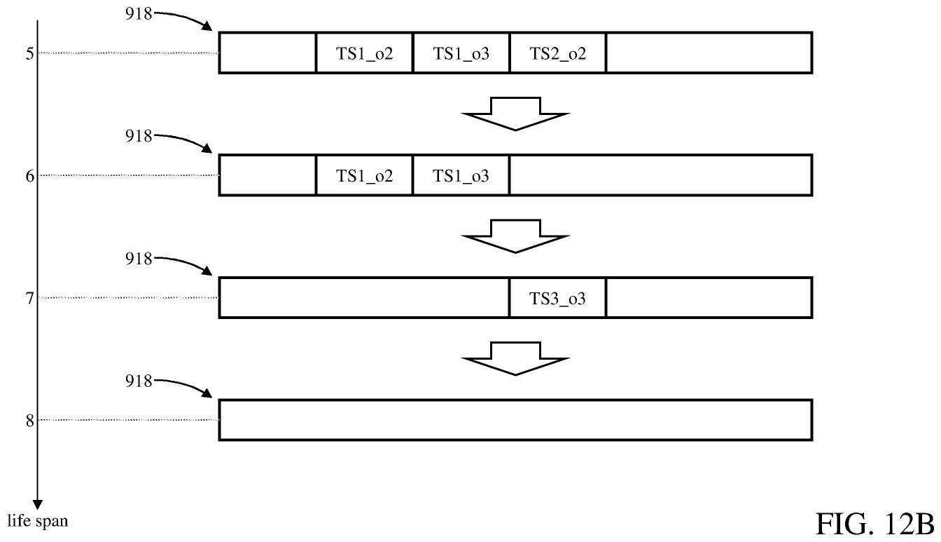

Step S250: Determining, according to the operation order, when an electronic device executing the AI model (more specifically, the processing circuit of the electronic device) deletes a target data from the memory. The target data is the output data of one of the sub-operators (i.e., the intermediate data of the AI network 100). This step will be discussed below with reference to FIG. 10, FIG. 11, FIG. 12A, and FIG. 12B.

Reference is made to FIG. 3 which is a result of splitting the tensors and operators in FIG. 1. In the embodiment of FIG. 3, the dimension according to which the tensor splitting operation is performed (i.e., step S210) is the second dimension of the tensor TS4 (i.e., H=3). As a result, the subtraction operator 110 is split into a subtraction sub-operator 110_1 (“SUB1”), a subtraction sub-operator 110_2 (“SUB2”), and a subtraction sub-operator 110_3 (“SUB3”); the convolution operator 120 is split into a convolution sub-operator 120_1 (“CONV1”), a convolution sub-operator 120_2 (“CONV2”), and a convolution sub-operator 120_3 (“CONV3”); the addition operator 130 is split into an addition sub-operator 130_1 (“ADD1”), an addition sub-operator 130_2 (“ADD2”), and an addition sub-operator 130_3 (“ADD3”). The tensor TS1 is split into a sub-tensor TS1_i1, a sub-tensor TS1_i2, and a sub-tensor TS1_i3, which are the input sub-tensors of the subtraction sub-operator 110_1, the subtraction sub-operator 110_2, and the subtraction sub-operator 110_3, respectively, the sizes of which are all [1,1,224,224], and which correspond to the same dimension of the tensor TS1 (e.g., the second dimension). The tensor TS4 is split into a sub-tensor TS3_o1, a sub-tensor TS3_o2, and a sub-tensor TS3_o3, which are the output sub-tensors of the addition sub-operator 130_1, the addition sub-operator 130_2, and the addition sub-operator 130_3, respectively, the sizes of which are all [1,1,224,224], and which correspond to the same dimension of the tensor TS4. The tensor TS3 is split into a sub-tensor TS3_i1, a sub-tensor TS3_i2, and a sub-tensor TS3_i3, which are the input sub-tensors of the addition sub-operator 130_1, the addition sub-operator 130_2, and the addition sub-operator 130_3, respectively, the sizes of which are all [1,1,224,224], and which correspond to the same dimension of the tensor TS3. The respective output sub-tensors of the convolution sub-operator 120_1, the convolution sub-operator 120_2, and the convolution sub-operator 120_3 (i.e., the sub-tensor TS2_o1, the sub-tensor TS2_o2, and the sub-tensor TS2_o3) are identical to the sub-tensor TS3_il, the sub-tensor TS3_i2, and the sub-tensor TS3_i3, respectively.

Note that due to visual field enlargement, the sub-tensor TS1_o1 (the sub-tensor TS1_o2 or the sub-tensor TS1_o3) outputted by the subtraction sub-operator 110_1 (the subtraction sub-operator 110_2 or the subtraction sub-operator 110_3) is not identical to the sub-tensor TS2_i1 (the sub-tensor TS2_i2 or the sub-tensor TS2_i3) inputted to the convolution sub-operator 120_1 (the convolution sub-operator 120_2 or the convolution sub-operator 120_3 ). More specifically, the sizes of the sub-tensors TS1_o1, TS1_o2, and TS1_o3 are all [1,1,224,224], but the sizes of the sub-tensor TS2_i1 and the sub-tensor TS2_i3 are both [1,2,224,224], and the size of the sub-tensor TS2_i2 is [1,3,224,224].

It can be seen from FIG. 3 that since the sub-tensor TS1_o1, the sub-tensor TS1_o2, and the sub-tensor TS1_o3 respectively correspond to the sub-tensor TS1_il, the sub-tensor TS1_i2, and the sub-tensor TS1_i3, and the sub-tensor TS1_il, the sub-tensor TS1_i2, and the sub-tensor TS1_i3 corresponds to the same dimension of the tensor TS1 (e.g., the second dimension), the sub-tensor TS1_o1, the sub-tensor TS1_o2, and the sub-tensor TS1_o3 also correspond to the same dimension of the tensor TS1.

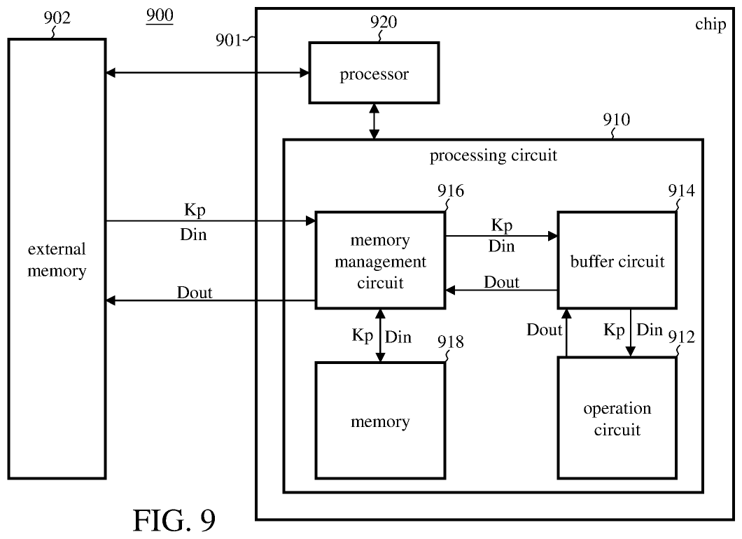

The process of FIG. 2 can effectively manage how long the target data is retained in the memory of the electronic device, which is helpful in reducing memory usage and/or memory bandwidth requirements. The details will be discussed below with reference to FIG. 9, FIG. 10, FIG. 11, FIG. 12A, and FIG. 12B.

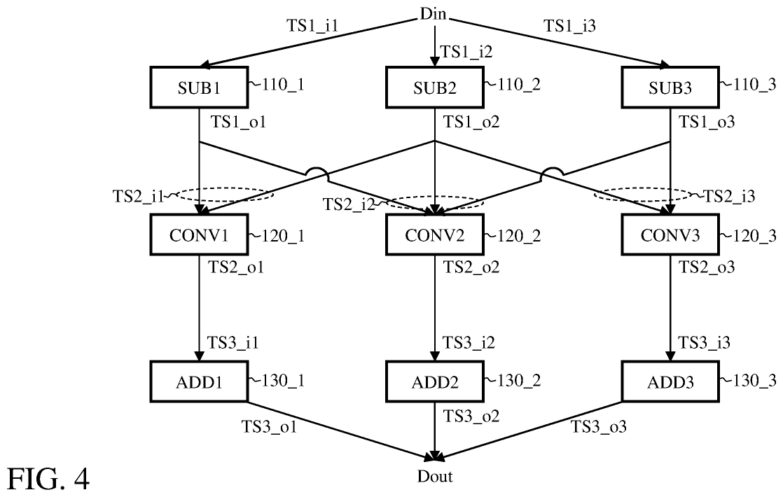

Based on the overlapping relationship between the sub-tensors split from the same tensor (see FIG. 3), the topology graph of the connections between the sub-operators as shown in FIG. 4 can be obtained. Specifically, the topology graph is obtained based on the overlapping relationship between the input sub-tensors of each sub-operator split from the same operator and the output sub-tensors of each sub-operator of the source operator on which that operator depends. As shown in the figure, the sub-tensor TS2_i1 inputted to the convolution sub-operator 120_1 includes the sub-tensor TS1_o1 and the sub-tensor TS1_o2. That is to say, the convolution sub-operator 120_1 cannot begin until the subtraction sub-operator 110_1 and the subtraction sub-operator 110_2 both finish. Similarly, the convolution sub-operator 120_2 cannot begin until the subtraction sub-operator 110_1, the subtraction sub-operator 110_2, and the subtraction sub-operator 110_3 all finish; the convolution sub-operator 120_3 cannot begin until the subtraction sub-operator 110_2 and the subtraction sub-operator 110_3 both finish. The addition sub-operator 130_1, the addition sub-operator 130_2, and the addition sub-operator 130_3 cannot begin until the convolution sub-operator 120_1, the convolution sub-operator 120_2, and the convolution sub-operator 120_3 finish, respectively.

Reference is made to FIG. 5 which is a detailed flowchart of step S230 in FIG. 2 according to an embodiment. The flowchart includes the following steps. The details of FIG. 5 are discussed below with reference to FIG. 4.

Step S510: Determining a target sub-operator. For example, the convolution sub-operator 120_1 is selected as the target sub-operator.

Step S520: Determining the source sub-operator(s) of the target sub-operator. Continuing the above example, since the source of the sub-tensor TS2_i1 inputted to the convolution sub-operator 120_1 includes the sub-tensor TS1_o1 and the sub-tensor TS1_o2, the source sub-operators of the convolution sub-operator 120_1 are the subtraction sub-operator 110_1 and the subtraction sub-operator 110_2 (i.e., the sub-tensor TS1_o1 outputted by the subtraction sub-operator 110_1 and the sub-tensor TS1_o2 outputted by the subtraction sub-operator 110_2 are the input sub-tensors of the convolution sub-operator 120_1). Similarly, the source sub-operators of the convolution sub-operator 120_2 are the subtraction sub-operator 110_1, the subtraction sub-operator 110_2, and the subtraction sub-operator 110_3, and the source sub-operators of the convolution sub-operator 120_3 are the subtraction sub-operator 110_2 and the subtraction sub-operator 110_3; the source sub-operator of the addition sub-operator 130_1 is the convolution sub-operator 120_1.

Step S530: Determining that the target sub-operator depends on the source sub-operator(s), that is, the source sub-operator(s) is(are) depended-upon sub-operator(s) of the target sub-operator. For example, the subtraction sub-operator 110_1, the subtraction sub-operator 110_2, and the subtraction sub-operator 110_3 are the depended-upon sub-operators of the convolution sub-operator 120_2.

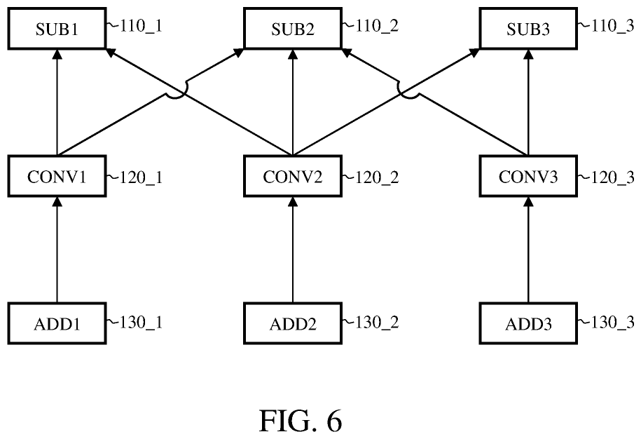

By taking each sub-operator in FIG. 4 as the target sub-operator in turn and repeating the process in FIG. 5, the dependency relationship among multiple sub-operators can be determined, as shown in FIG. 6. The convolution sub-operator 120_1 depends on the subtraction sub-operator 110_1 and the subtraction sub-operator 110_2. The convolution sub-operator 120_2 depends on the subtraction sub-operator 110_1, the subtraction sub-operator 110_2, and the subtraction sub-operator 110_3. The convolution sub-operator 120_3 depends on the subtraction sub-operator 110_2 and the subtraction sub-operator 110_3. The addition sub-operator 130_1, the addition sub-operator 130_2, and the addition sub-operator 130_3 depend on the convolution sub-operator 120_1, the convolution sub-operator 120_2, and the convolution sub-operator 120_3 , respectively.

Reference is made to FIG. 7 which is a detailed flowchart of step S240 of FIG. 2 according to an embodiment. The flowchart includes the following steps. The flowchart in FIG. 7 is based on the depth first search algorithm.

Step S710: Searching for a sub-operator whose indegree is 0, and marking the sub-operator whose indegree is 0 as a target sub-operator and visited. A sub-operator whose indegree is 0 is a sub-operator on which no other sub-operator depends. Taking FIG. 6 as an example, the addition sub-operator 130_1, the addition sub-operator 130_2, and the addition sub-operator 130_3 are sub-operators whose indegree is 0, that is, the top-level sub-operators.

Step S720: Determining whether a sub-operator whose indegree is 0 is found. If YES, the flow proceeds to step S730; if NO, the flow proceeds to step S795. In the following, the addition sub-operator 130_1 is used as an example for discussion.

Step S730: Searching for an unvisited depended-upon sub-operator of the target sub-operator (i.e., an unvisited sub-operator on which the target sub-operator depends). As shown in FIG. 6, since the convolution sub-operator 120_1 is a depended-upon sub-operator of the addition sub-operator 130_1 (i.e., the addition sub-operator 130_1 depends on the convolution sub-operator 120_1), the convolution sub-operator 120_1 is found in step S730.

Step S740: Determining whether a depended-upon sub-operator is found. If YES, the flow proceeds to step S750; if NO, the flow proceeds to step S760.

Step S750: Marking the depended-upon sub-operator as the target sub-operator and visited, and then performing step S730. Continuing the above example, in step S750, the convolution sub-operator 120_1 is marked as the target sub-operator and visited, and then the depended-upon sub-operator of the convolution sub-operator 120_1 is found when step S730 is performed again (assuming that the subtraction sub-operator 110_1 is found). Then, step S730 and step S740 are performed again; at this point, because the subtraction sub-operator 110_1 does not depend on any sub-operator (i.e., there is no depended-upon sub-operator, so the result of step S740 is NO), the flow proceeds to step S760.

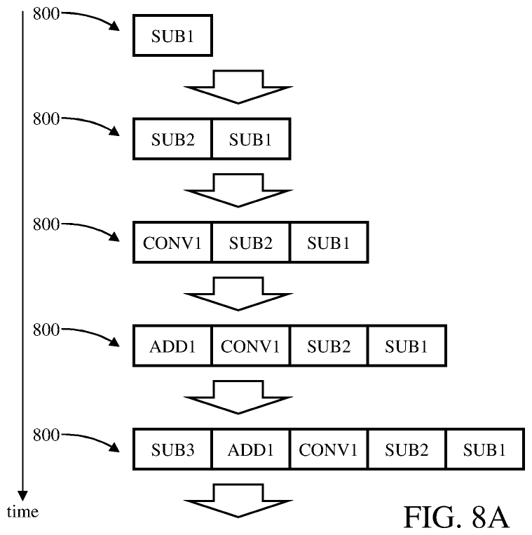

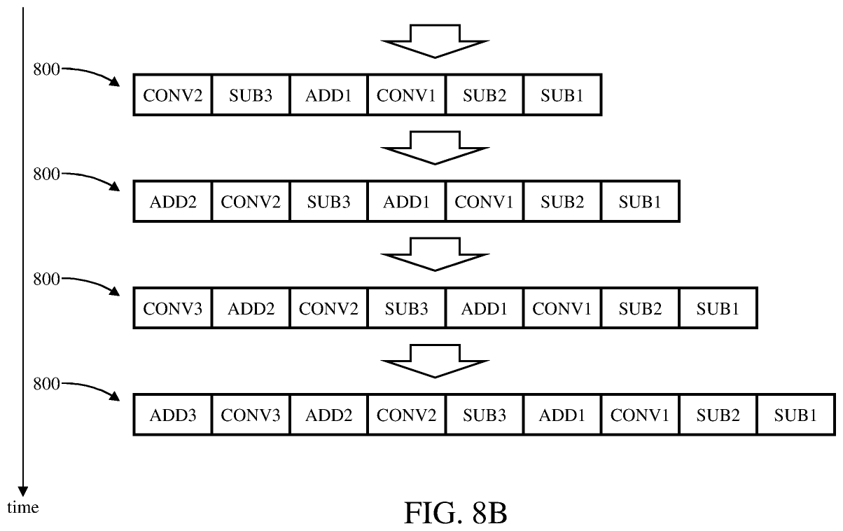

Step S760: Adding the target sub-operator to a queue 800. Continuing the above example, the subtraction sub-operator 110_1 is added to the queue 800 at this point. Reference is made to FIG. 8A and FIG. 8B which show the change in the content of the queue 800 (FIG. 8B continues FIG. 8A). As shown in the first row of FIG. 8A, the queue 800 includes only the subtraction sub-operator 110_1 (“SUB1”) at this point.

Step S770: Determining whether the target sub-operator is the top-level sub-operator (i.e., a sub-operator whose indegree is 0). If YES, the flow proceeds to step S710; if NO, the flow proceeds to step S780. Continuing the above example, since the subtraction sub-operator 110_1 is not the top-level sub-operator, the result of step S770 is NO.

Step S780: Determining an upper-level sub-operator that depends on the target sub-operator (i.e., back to the sub-operator in the upper level), and marking the upper-level sub-operator as the target sub-operator. Continuing the above example, at this point the process is back to the convolution sub-operator 120_1.

Step S790: Determining whether there is(are) unmarked depended-upon sub-operator(s). Continuing the above example, because at this point there is(are) still unmarked sub-operator(s) (i.e., the subtraction sub-operator 110_2) among the depended-upon sub-operators (i.e., the subtraction sub-operator 110_1 and the subtraction sub-operator 110_2) of the target sub-operator (i.e., the convolution sub-operator 120_1), the result of step S790 is YES. Next, the following steps of the flow are performed: step S730 (the subtraction sub-operator 110_2 is found)→step S740 (the result is YES)→step S750 (the subtraction sub-operator 110_2 is marked as visited)→step S730 (the depended-upon sub-operator of the subtraction sub-operator 110_2 is not found)→step S740 (the result is NO)→step S760 (the subtraction sub-operator 110_2 is added to the queue 800 (as shown in the second row of FIG. 8A))→step S770 (the result is NO)→step S780 (the convolution sub-operator 120_1 is marked as the target sub-operator)→step S790. At this point, because all of the depended-upon sub-operators (i.e., the subtraction sub-operator 110_1 and the subtraction sub-operator 110_2) of the target sub-operator (i.e., the convolution sub-operator 120_1) have been visited, the result of step S790 is NO, and therefore the convolution sub-operator 120_1 is added to the queue 800 in the next step S760 (as shown in the third row of FIG. 8A). The process continues to perform step S770, step S780 (in which the addition sub-operator 130_1 is marked as the target sub-operator), step S790, and step S760 (in which the addition sub-operator 130_1 is added to the queue 800). Then, the result of step S770 is YES (because the addition sub-operator 130_1 is the top-level sub-operator), and the flow returns to step S710 to select the next sub-operator whose indegree is 0 (e.g., the addition sub-operator 130_2).

The above steps S710 to S790 will be performed repeatedly (the process of adding all of the sub-operators of FIG. 6 in the queue 800 is shown in FIG. 8A and FIG. 8B and the details are omitted herein for brevity) until all of the sub-operators whose indegree is 0 have been visited (i.e., the result of step S720 is NO, and the flow proceeds to step S795).

Step S795: Taking out all of the sub-operators in the queue 800 in sequence. Taking FIG. 8B as an example, the order in which the sub-operators are taken out of the queue 800 (i.e., the order in which the sub-operators are executed) is: SUB1→SUB2→CONV1→ . . . →CONV3→ADD3 (i.e., opposite to the order in which the sub-operators are added to the queue).

FIG. 9 is a functional block diagram of the electronic device according to an embodiment of the present invention. The electronic device 900 includes a chip 901 and an external memory 902 (e.g., a dynamic random access memory, DRAM). The chip 901 and the external memory 902 are coupled or electrically connected to each other. The chip 901 includes a processing circuit 910 and a processor 920. The processing circuit 910 and the processor 920 are coupled or electrically connected to each other.

The processor 920 controls the processing circuit 910 to jointly perform the functions of the chip 901. The processor 920 may be a circuit or an electronic component capable of executing programs, such as a central processing unit (CPU), a microprocessor, a microprocessor unit, a digital signal processor (DSP), an application specific integrated circuit (ASIC), or their equivalent circuits.

The processing circuit 910 may be an intelligence processing unit (IPU) or a neural-network processing unit (NPU). The processing circuit 910 includes an operation circuit 912 (e.g., including but not limited to a convolution engine, a vector engine), a buffer circuit 914 (e.g., including but not limited to multiple registers), a memory management circuit 916 (e.g., a direct memory access (DMA) circuit), and a memory 918 (e.g., a static random access memory (SRAM)). The data that the operation circuit 912 requires to perform the convolution operation or vector operation is stored in the buffer circuit 914. The memory 918 can store the output sub-tensors of each sub-operator in FIG. 3.

The external memory 902 stores the input data Din, the kernel parameters Kp, and the output data Dout. The memory management circuit 916 is used to read the input data Din and the kernel parameters Kp from the external memory 902 and store them in the memory 918, read at least one subset of the input data Din and at least one subset of the kernel parameters Kp from the memory 918 and store them in the buffer circuit 914, and store the output data Dout generated by the operation circuit 912 in the external memory 902.

The details of step S250 of FIG. 2 will be discussed below with reference to FIG. 9, FIG. 10, FIG. 11, FIG. 12A, and FIG. 12B. FIG. 10 shows a list of life spans of the output sub-tensors of some of the sub-operators of FIG. 3. The horizontal axis corresponds to the operation order of the aforementioned sub-operators. Note that the operation order does not necessarily correspond to the actual time length. More specifically, the sub-tensor TS1_o1 outputted by the subtraction sub-operator 110_1 is generated at the time point of operation order 0 and ends (i.e., will not be used by other sub-operators) at the time point of operation order 5. Note that the sub-tensor TS3_o1, the sub-tensor TS3_o2, and the sub-tensor TS3_o3 start to be generated at the time points of operation orders 3, 6, and 8, respectively. However, because the sub-tensor TS3_o1, the sub-tensor TS3_o2, and the sub-tensor TS3_o3 are not deleted from the memory 918 in advance (because each is a subset of the output data Dout), the life span list of FIG. 10 does not show these three sub-tensors.

The details of step S250 in FIG. 2 include allocating the memory 918 according to the life span list of FIG. 10, and the process of allocating the memory 918 is shown in FIG. 11. FIG. 12A, and FIG. 12B are schematic diagrams of an alive list according to an embodiment of the present invention. Please refer to FIG. 10, FIG. 11, FIG. 12A, and FIG. 12B for the following discussion. The alive list is used to show the activity status of the sub-tensors in the memory 918, more specifically, to show the time points when the sub-tensors are stored in the memory 918 and deleted from the memory 918. FIG. 11 includes the following steps.

Step S1110: Establishing a life span list. An example of the life span list is shown in FIG. 10.

Step S1120: Searching the life span list for the sub-tensor(s) whose life span(s) is(are) currently alive. For example, the sub-tensor TS1_o1 becomes alive at the time point of operation order 0, and the alive period of the sub-tensor TS1_o1 is from the time point of operation order 0 to the time point of operation order 5.

Step S1130: Adding the alive sub-tensor(s) to the alive list. As shown in FIG. 12A, the sub-tensor TS1_o1 is added to the alive list when the life span is 0.

Step S1140: Allocating memory for the alive sub-tensor(s), that is, arranging corresponding storage space in the memory 918. Continuing the above example, as shown in FIG. 12A, part of the memory 918 is allocated to the sub-tensor TS1_o1 when the life span is 0.

Step S1150: Deleting the sub-tensor(s) that is(are) no longer alive in the alive list. For example, since the sub-tensor TS2_o1 in FIG. 10 is no longer alive after the time point of operation order 3, the sub-tensor TS2_o1 is deleted when the life span is 3 in FIG. 12A.

Step S1160: Releasing the memory corresponding to the sub-tensor(s) that is(are) no longer alive. In response to the deletion of the sub-tensor(s) from the alive list in the previous step, this step releases the corresponding storage space in the memory 918, so that the memory 918 can be used in a more timely and flexible manner.

Step S1170: Adding one to the life span.

If there is no sub-tensor that is no longer alive in the current life span, steps S1150 and S1160 are skipped to directly perform step S1170.

Step S1180: Determining whether the life span is over (i.e., determining whether the operation order in FIG. 10 is over). If YES, then the flow of FIG. 11 ends; if NO, the flow proceeds to step S1120 to continue searching for alive sub-tensors.

As mentioned above, according to the life span list in FIG. 10 and the flowchart in FIG. 11, the alive lists in FIG. 12A and FIG. 12B can be obtained. The life span in FIG. 12A and FIG. 12B corresponds to the operation order in FIG. 10. For example, in FIG. 10, the sub-tensor TS1_o1 is generated at the time point of operation order 0 and ends at the time point of operation order 5; therefore, the life span of the sub-tensor TS1_o1 in FIG. 12A is from 0 to 4. Similarly, in FIG. 10, the sub-tensor TS2_o2 exists between the time point of operation order 5 and the time point of operation order 6; therefore, in FIG. 12B, the sub-tensor TS2_o2 exists only in life span 5. In this way, the developer or designer of the chip 901 can design or manage the memory 918 according to the alive list in FIG. 12A and FIG. 12B. Therefore, the bandwidth requirement of the external memory 902 can be reduced (i.e., the overall performance of the external memory 902 can be improved) without increasing the memory 918 (which saves costs), or the memory 918 can be saved without increasing the memory bandwidth of the external memory 902.

For comparison purposes, if the operators and tensors in FIG. 1 are not split, the chip developer must pre-allocate one of the storage blocks of the memory 918 to the tensor TS2 (whose total amount of data is equivalent to the sum of the amount of data of the sub-tensor TS1_o1, the amount of data of the sub-tensor TS1_o2, and the amount of data of the sub-tensor TS1_o3), and the storage block cannot be released until the convolution operator 120 is completed. In addition, if the sub-operators that are split from an operator are not sorted according to their operation orders, operation must be performed on the same sub-tensor (such as the sub-tensor TS1_i1) repeatedly for multiple times. As a result, the data volume of the entire AI model increases, which causes the cost to increase (because the demand on the memory 918 increases) or causes the performance to decrease (because bandwidth requirements of the external memory 902 increases). Since the number of operators and the sizes of the tensors are very large in real operations, the effect achieved by the present invention is quite remarkable.

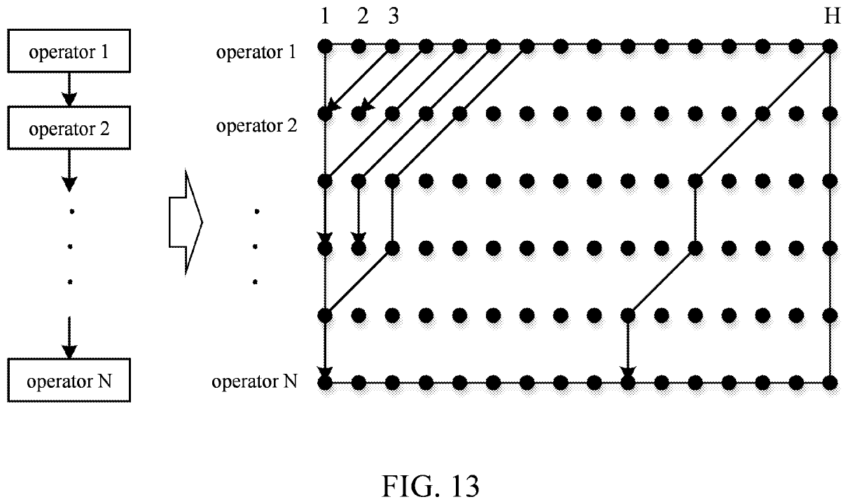

The invention may be extended to AI models containing more operators. Reference is made to FIG. 13 which is a schematic diagram of another AI model. The left side of FIG. 13 shows that the AI model contains N operators (operator 1, operator 2, . . . , operator N), and the right side of FIG. 13 shows that an operator is split into H sub-operators. Arrows indicate the dependency relationship among the sub-operators during execution. For example, the first sub-operator of the operator 2 cannot be executed until the third sub-operator of the operator 1 is completed.

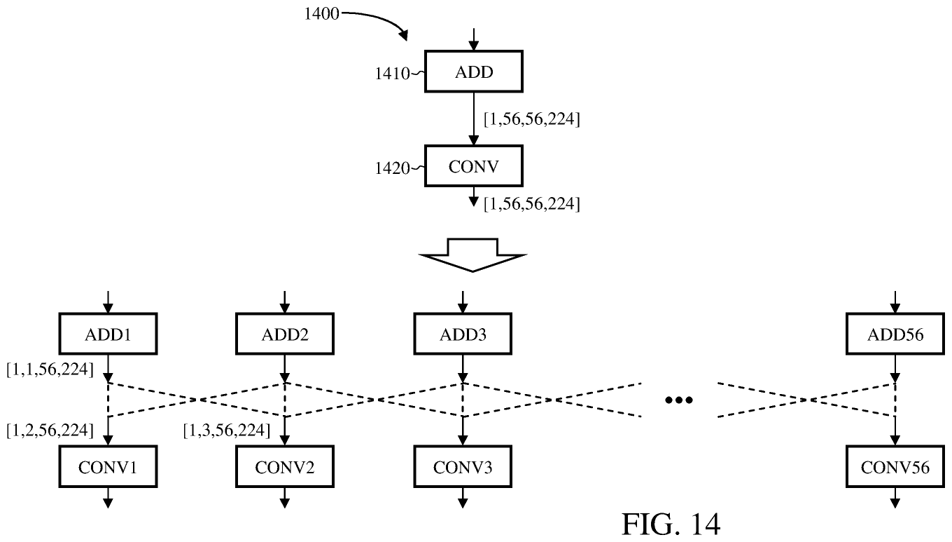

FIG. 14 is a schematic diagram of another AI model. The AI network 1400 includes an addition operator 1410 and a convolution operator 1420, and the sizes of the tensors are [1,56,56,224]. After splitting (as shown in the lower part of FIG. 14), the addition operator 1410 and the convolution operator 1420 are each split into 56 sub-operators (“ADD1” to “ADD56” and “CONV1” to “CONV56”). Each addition sub-operator (“ADD1” to “ADD56”) outputs a sub-tensor of size [1,1,56,224]. However, not all of the convolution sub-operators (“CONV1” to “CONV56”) have input sub-tensors of the same size. More specifically, the size of the sub-tensor inputted to the first convolution sub-operator (“CONV1”) is [1,2,56,224], and the size of the sub-tensor inputted to the second convolution sub-operator (“CONV2”) is [1,3,56,224] (i.e., due to visual field enlargement).

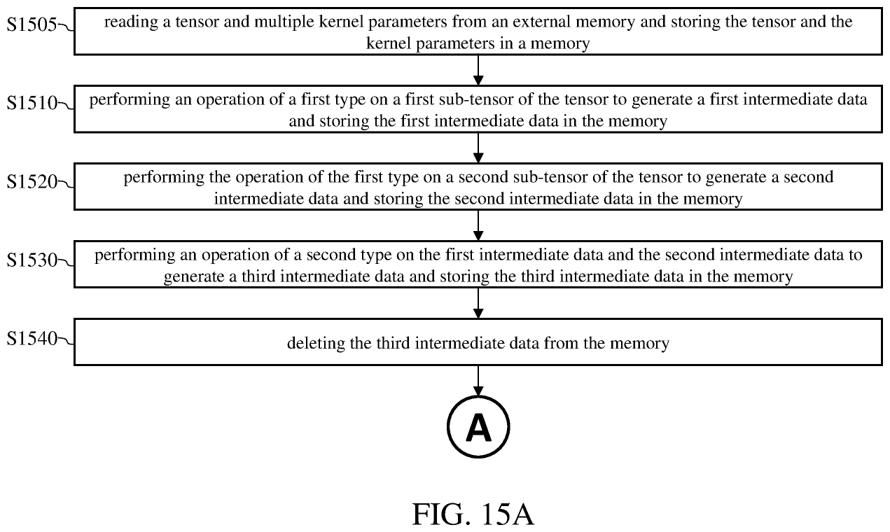

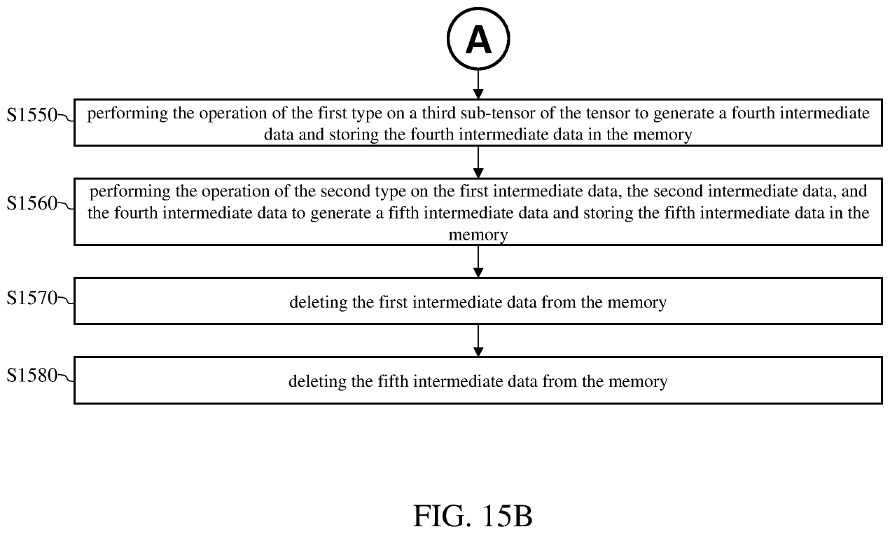

FIG. 15A and FIG. 15B are flowcharts of a method of executing the AI model according to an embodiment of the present invention. FIG. 15A and FIG. 15B include the following steps.

Step S1505: The memory management circuit 916 reads a tensor (i.e., the input data Din) and multiple kernel parameters Kp from the external memory 902 and stores the tensor and the kernel parameters Kp in the memory 918.

Step S1510: The processing circuit 910 (more specifically, the operation circuit 912) performs an operation of a first type on a first sub-tensor of the tensor to generate a first intermediate data, and the memory management circuit 916 stores the first intermediate data in the memory 918. Taking FIG. 4 as an example, the first sub-tensor may be the input sub-tensor of the subtraction sub-operator 110_1 (i.e., the sub-tensor TS1_i1), the operation of the first type may be a subtraction operation (a type of vector operation), and the first intermediate data may be an output sub-tensor of the subtraction sub-operator 110_1 (i.e., the sub-tensor TS1_o1). Taking FIG. 14 as an example, the first sub-tensor may be the input sub-tensor of an addition sub-operator (e.g., “ADD1”), the operation of the first type may be an addition operation (a type of vector operation), and the first intermediate data may be an output sub-tensor of the addition sub-operator (e.g., “ADD1”).

Step S1520: The processing circuit 910 (more specifically, the operation circuit 912) performs the operation of the first type on a second sub-tensor of the tensor to generate a second intermediate data, and the memory management circuit 916 stores the second intermediate data in the memory 918. Taking FIG. 4 as an example, the second sub-tensor may be the input sub-tensor of the subtraction sub-operator 110_2 (i.e., the sub-tensor TS1_i2), the operation of the first type may be the subtraction operation, and the second intermediate data may be the output sub-tensor of the subtraction sub-operator 110_2 (i.e., the sub-tensor TS1_o2). Taking FIG. 14 as an example, the second sub-tensor may be the input sub-tensor of an addition sub-operator (e.g., “ADD2”), the operation of the first type may be the addition operation, and the second intermediate data may be an output sub-tensor of the addition sub-operator (e.g., “ADD2”).

Step S1530: The processing circuit 910 (more specifically, the operation circuit 912) performs an operation of a second type on the first intermediate data and the second intermediate data to generate a third intermediate data, and the memory management circuit 916 stores the third intermediate data in the memory 918. Taking FIG. 4 and FIG. 14 as an example, the operation of the second type may be a convolution operation (e.g., the convolution sub-operator 120_1 or “CONV1”), and the third intermediate data may be the outcome of the convolution operation (e.g., the sub-tensor TS2_o1 of FIG. 4).

Step S1540: The memory management circuit 916 deletes the third intermediate data from the memory 918. As shown in FIG. 10, since the sub-tensor TS2_o1 is no longer used in operations after the time point of operation order 3 (i.e., the sub-tensor TS2_o1 becomes unalive from life span 3 in FIG. 12A), the sub-tensor TS2_o1 can be deleted from the memory 918 to free a portion of the memory 918.

Step S1550: The processing circuit 910 (more specifically, the operation circuit 912) performs the operation of the first type on a third sub-tensor of the tensor to generate a fourth intermediate data, and the memory management circuit 916 stores the fourth intermediate data in the memory 918. Taking FIG. 4 as an example, the third sub-tensor may be the input sub-tensor of the subtraction sub-operator 110_3 (i.e., the sub-tensor TS1_i3), the operation of the first type may be the subtraction operation, and the fourth intermediate data may be an output sub-tensor of the subtraction sub-operator 110_3 (i.e., the sub-tensor TS1_o3). Taking FIG. 14 as an example, the third sub-tensor may be the input sub-tensor of an addition sub-operator (e.g., “ADD3”), the operation of the first type may be the addition operation, and the fourth intermediate data may be the output sub-tensor of an addition sub-operator (e.g., “ADD3”).

Step S1560: The processing circuit 910 (more specifically, the operation circuit 912) performs the operation of the second type on the first intermediate data, the second intermediate data, and the fourth intermediate data to generate a fifth intermediate data, and the memory management circuit 916 stores the fifth intermediate data in the memory 918. Taking FIG. 4 and FIG. 14 as an example, the operation of the second type may be the convolution operation (e.g., the convolution sub-operator 120_2 or “CONV2”), and the fifth intermediate data may be the outcome of the convolution operation (e.g., the sub-tensor TS2_o2 of FIG. 4).

Step S1570: The memory management circuit 916 deletes the first intermediate data from the memory 918. As shown in FIG. 10, since the sub-tensor TS1_o1 is no longer used in operations after the time point of operation order 5 (i.e., the sub-tensor TS1_o1 becomes unalive from life span 5 in FIG. 12B), the sub-tensor TS1_o1 can be deleted from the memory 918 to free a portion of the memory 918.

Step S1580: The memory management circuit 916 deletes the fifth intermediate data from the memory 918. As shown in FIG. 10, since the sub-tensor TS2_o2 is no longer used in operations after the time point of operation order 6 (i.e., the sub-tensor TS2_o2 becomes unalive from life span 6 in FIG. 12B), the sub-tensor TS2_o2 can be deleted from the memory 918 to free a portion of the memory 918.

From the discussion of FIG. 15A and FIG. 15B, the developer of the chip 901 may arrange the instructions executed by the processing circuit 910 (more specifically, the memory management circuit 916) in advance according to the usage status of the memory 918 to achieve the purpose of making good use of the memory 918. Note that in some embodiments, the instructions are provided by the processor 920 to the processing circuit 910.

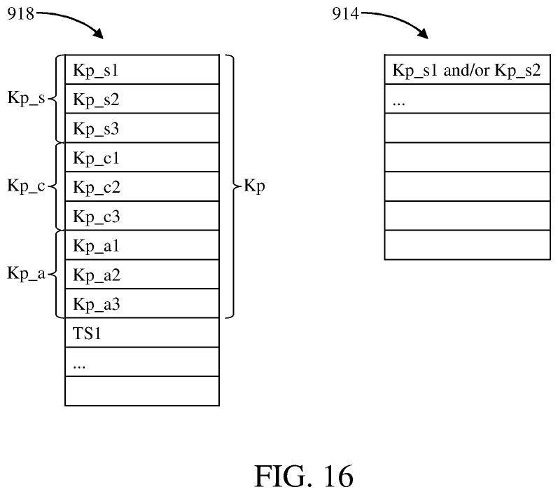

Reference is made to FIG. 16 which is a schematic diagram of stored contents of the buffer circuit 914 and the memory 918 according to an embodiment of the present invention. In the example of FIG. 16, the kernel parameters Kp stored in the memory 918 include the subtraction kernel parameters Kp_s (a type of vector kernel parameters), the convolution kernel parameters Kp_c, and the addition kernel parameters Kp_a (a type of vector kernel parameters).

The subtraction kernel parameters Kp_s include a sub-parameter Kp_s1, a sub-parameter Kp_s2, and a sub-parameter Kp_s3. The subtraction kernel parameters Kp_s are the parameters required by the subtraction operator 110 to perform the subtract operation on the tensor TS1, and the sub-parameter Kp_s1, the sub-parameter Kp_s2, and sub-parameter Kp_s3 may correspond to the subtraction sub-operator 110_1, the subtraction sub-operator 110_2, and the subtraction sub-operator 110_3 in FIG. 4, respectively. That is to say, when performing the subtraction sub-operator 110_1 (110_2 or 110_3), the operation circuit 912 refers to the sub-parameter Kp_s1 (Kp_s2 or Kp_s3) to perform operations on the sub-tensor TS1_i1 (TS1_i2 or TS1_i3). In some embodiments, the sub-parameter Kp_s1 is different from the sub-parameters Kp_s2 and Kp_s3, and the sub-parameter Kp_s2 is different from the sub-parameter Kp_s3.

The addition kernel parameters Kp_a include a sub-parameter Kp_a1, a sub-parameter Kp_a2, and a sub-parameter Kp_a3. The addition kernel parameters Kp_a are the parameters required by the addition operator 130 to perform the addition operation on the tensor TS3, and the sub-parameter Kp_a1, the sub-parameter Kp_a2, and the sub-parameter Kp_a3 may correspond to the addition sub-operator 130_1, the addition sub-operator 130_2, and the addition sub-operator 130_3 in FIG. 4, respectively. That is to say, when performing the addition sub-operator 130_1 (130_2 or 130_3), the operation circuit 912 refers to the sub-parameter Kp_a1 (Kp_a2 or Kp_a3) to perform operations on the sub-tensor TS3_i1 (TS3_i2 or TS3_i3). In some embodiments, the sub-parameter Kp_a1 is different from the sub-parameters Kp_a2 and Kp_a3, and the sub-parameter Kp_a2 is different from the sub-parameter Kp_a3.

The convolution kernel parameters Kp_c include a sub-parameter Kp_c1, a sub-parameter Kp_c2, and a sub-parameter Kp_c3. Unlike the subtraction and addition operations, even though the convolution operator and its tensor have been split, the convolution sub-operator 120_1, the convolution sub-operator 120_2, and the convolution sub-operator 120_3 still need to refer to all of the convolution kernel parameters Kp_c to perform the convolution operation.

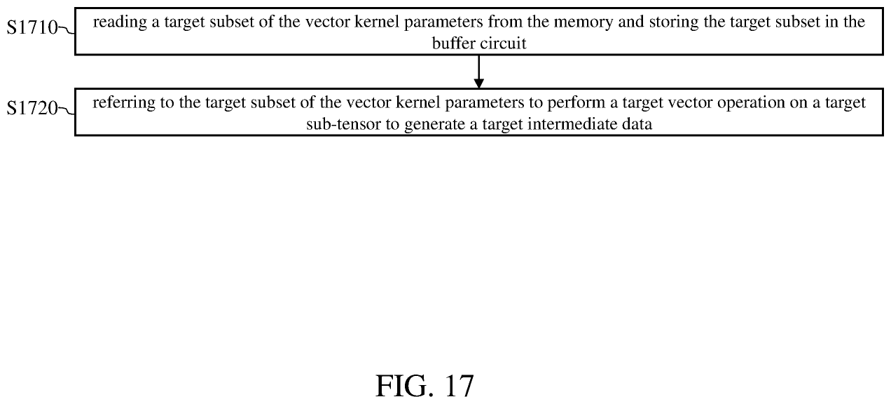

Reference is made to FIG. 17 which is a detailed flowchart of step S1510 or step S1520 of FIG. 15A. The flowchart includes the following steps. Please also refer to FIG. 16 for the following discussion.

Step S1710: The memory management circuit 916 reads a target subset of the vector kernel parameters from the memory 918 and stores the target subset in the buffer circuit 914. More specifically, for step S1510, the target subset may be the sub-parameter Kp_s1. For step S1520, the target subset may be the sub-parameter Kp_s2. As shown in FIG. 16, the buffer circuit 914 stores the sub-parameter Kp_s1 and/or the sub-parameter Kp_s2, and other data (e.g., the sub-tensors to be computed). Since the operation of the first type (e.g., the vector operation) in step S1510 and step S1520 only needs a subset of the subtraction kernel parameters Kp_s (i.e., the target subset), the buffer circuit 914 does not need to store all of the subtraction kernel parameters Kp_s at this point to save storage space. In some embodiments, the memory management circuit 916 stores the sub-parameter Kp_s1 (Kp_s2) in the buffer circuit 914 prior to step S1510 (S1520) and deletes the sub-parameter Kp_s1 (Kp_s2) from the buffer circuit 914 after completion of step S1510 (S1520) to save storage space.

Step S1720: The operation circuit 912 refers to the target subset of the vector kernel parameters to perform a target vector operation on a target sub-tensor to generate a target intermediate data. More specifically, for step S1510, the target sub-tensor may be the sub-tensor TS1_i1, the target vector operation may be the subtraction sub-operator 110_1, and the target intermediate data may be the sub-tensor TS1_o1. For step S1520, the target sub-tensor may be the sub-tensor TS1_i2, the target vector operation may be the subtraction sub-operator 110_2, and the target intermediate data may be the sub-tensor TS1_o2. For FIG. 14, the target subset may be the sub-parameter Kp_a1, the target sub-tensor may be the input sub-tensor of an addition sub-operator (e.g., “ADD1”), the target vector operation may be the addition sub-operator, and the first intermediate data may be the output sub-tensor of the addition sub-operator.

As mentioned above, because an original tensor is split into multiple sub-tensors, performing vector operations on the sub-tensor only needs to refer to a subset of the kernel parameters.

People having ordinary skill in the art can understand the details of step S1550 of FIG. 15B from the description of FIG. 17, so the details are omitted herein for brevity. For example, for step S1550, the target subset may be the sub-parameter Kp_s3, the target sub-tensor may be the sub-tensor TS1_i3, the target vector operation may be the subtraction sub-operator 110_3, and the target intermediate data may be the sub-tensor TS1_o3.

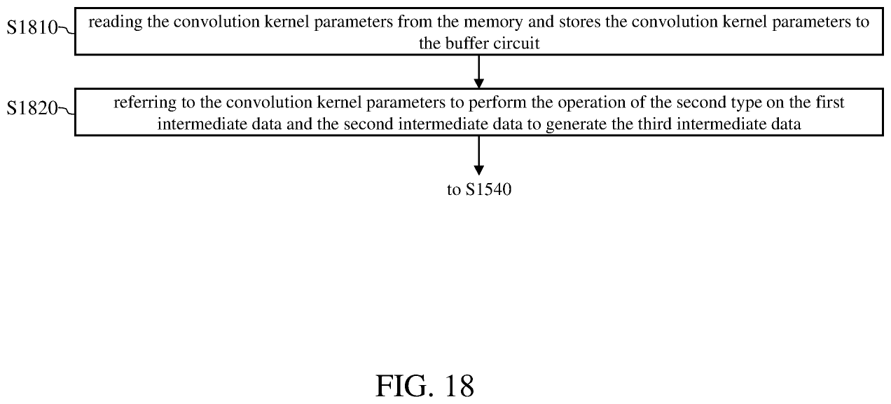

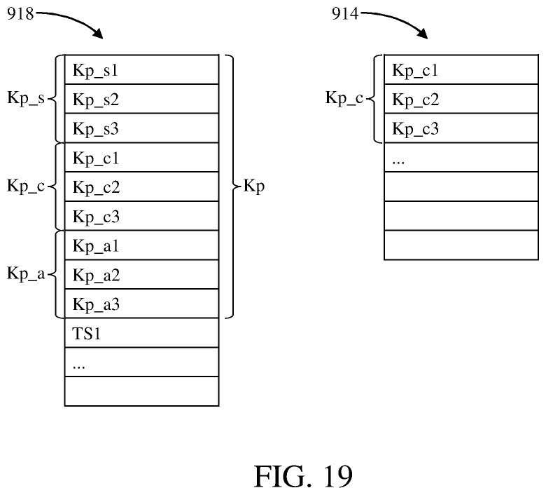

Reference is made to FIG. 18 which is a detailed flowchart of step S1530 of FIG. 15A. The flowchart includes the following steps. Please also refer to FIG. 19 for the following discussion.

Step S1810: The memory management circuit 916 reads the convolution kernel parameters Kp_c from the memory 918 and stores the convolution kernel parameters Kp_c to the buffer circuit 914. As shown in FIG. 19, the buffer circuit 914 stores the convolution kernel parameters Kp_c and other data (e.g., the sub-tensors to be computed) before the convolution operation starts. Since the operation of the second type (e.g., the convolution operation) in step S1530 requires all of the convolution kernel parameters Kp_c, the buffer circuit 914 needs to store all of the convolution kernel parameters Kp_c at this point.

Step S1820: The operation circuit 912 refers to the convolution kernel parameters Kp_c to perform the operation of the second type on the first intermediate data and the second intermediate data to generate the third intermediate data. Referring to the convolution kernel parameters Kp_c to perform the convolution operation on the tensors is well known to people having ordinary skill in the art, so the details are omitted for brevity. In some embodiments, the memory management circuit 916 deletes the convolution kernel parameters Kp_c from the buffer circuit 914 after step S1820 is completed.

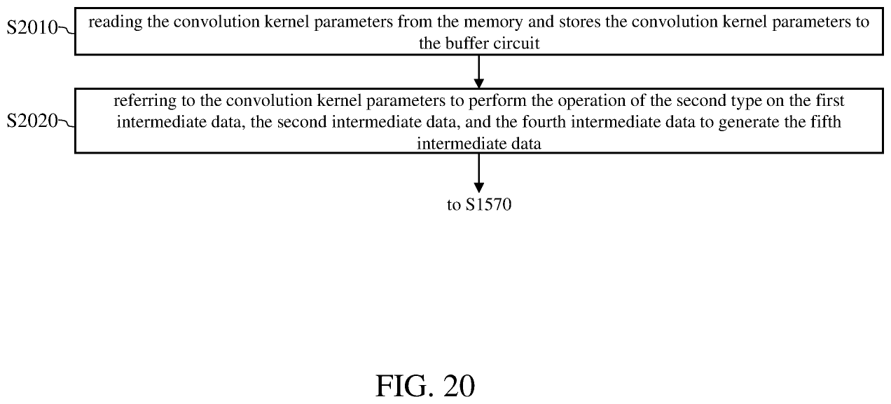

Reference is made to FIG. 20 which is a detailed flowchart of step S1560 of FIG. 15B. The flowchart includes the following steps. Please also refer to FIG. 19 for the following discussion.

Step S2010: Step S2010 is similar to step S1810, and the details are omitted for brevity. Note that if the memory management circuit 916 does not delete the convolution kernel parameters Kp_c from the buffer circuit 914 after step S1530 is completed, then step S2010 may be skipped.

Step S2020: The operation circuit 912 refers to the convolution kernel parameters Kp_c to perform the operation of the second type on the first intermediate data, the second intermediate data, and the fourth intermediate data to generate the fifth intermediate data. Step S2020 is similar to step S1820, and the details are omitted for brevity.

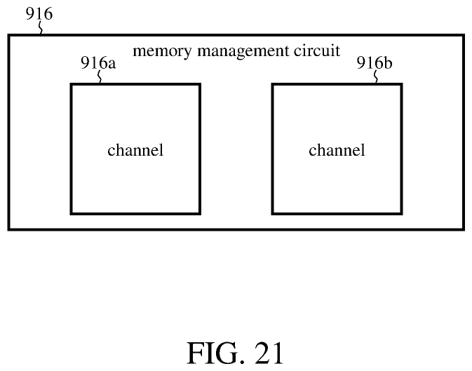

Reference is made to FIG. 21 which is a functional block diagram of the memory management circuit 916 according to an embodiment of the present invention. The memory management circuit 916 includes at least two channels (the channel 916a and the channel 916b), each channel can operate independently, and multiple channels can operate simultaneously. Based on this feature, the present invention further splits the sub-operators and sub-tensors into several small blocks, so that the processing circuit 910 can use a multi-stage pipeline technique to perform operations on the AI model to improve the performance of the chip 901.

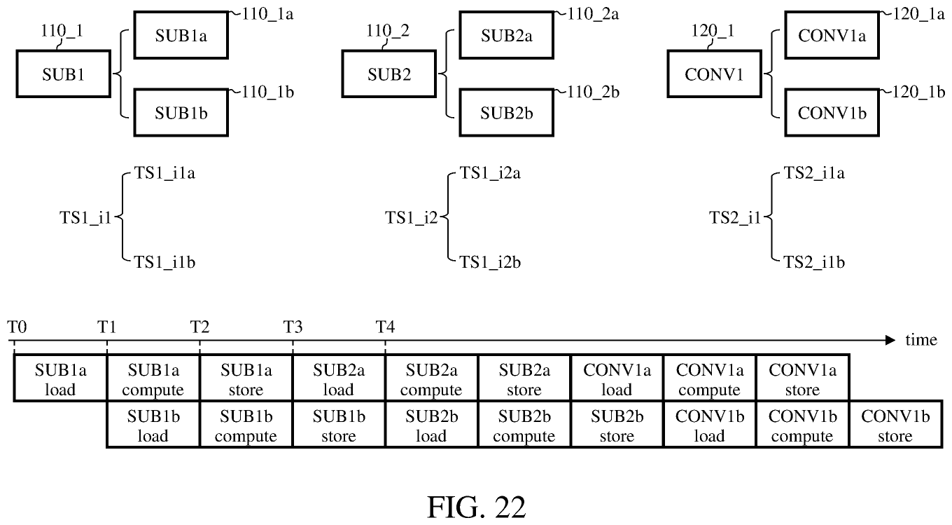

Reference is made to FIG. 22 which is a schematic diagram of a multi-stage pipeline of the present invention. In FIG. 22, the subtraction sub-operator 110_1, the subtraction sub-operator 110_2, and the convolution sub-operator 120_1 are taken as an example for discussion. In the example of FIG. 22, the subtraction sub-operator 110_1 is further split into an operation block 110_1a (“SUB1a”) and an operation block 110_1b (“SUB1b”), and the sub-tensor TS1_i1 is further split into a data block TS1_i1a and a data block TS1_i1b; the subtraction sub-operator 110_2 is further split into an operation block 110_2a (“SUB2a”) and an operation block 110_2b (“SUB2b”), and the sub-tensor TS1_i2 is further split into a data block TS1_i2a and a data block TS1_i2b; the convolution sub-operator 120_1 is further split into an operation block 120_1a (“CONV1a”) and an operation block 120_1b(“CONV1b”), and the sub-tensor TS2_i1 is further split into a data block TS2_i1a and a data block TS2_i1b. In this way, when the channel 916a performs the operations related to the operation block 110_1a (between the time point T0 and the time point T3), the channel 916b can substantially simultaneously perform the operations related to the operation block 110_1b (between the time point T1 and the time point T4). In comparison with a single-stage pipeline (i.e., without using multiple channels at the same time to perform operations on the AI model), using two channels at the same time can save about half the time. Similarly, using N channels at the same time takes about 1/N the processing time of the single-stage pipeline.

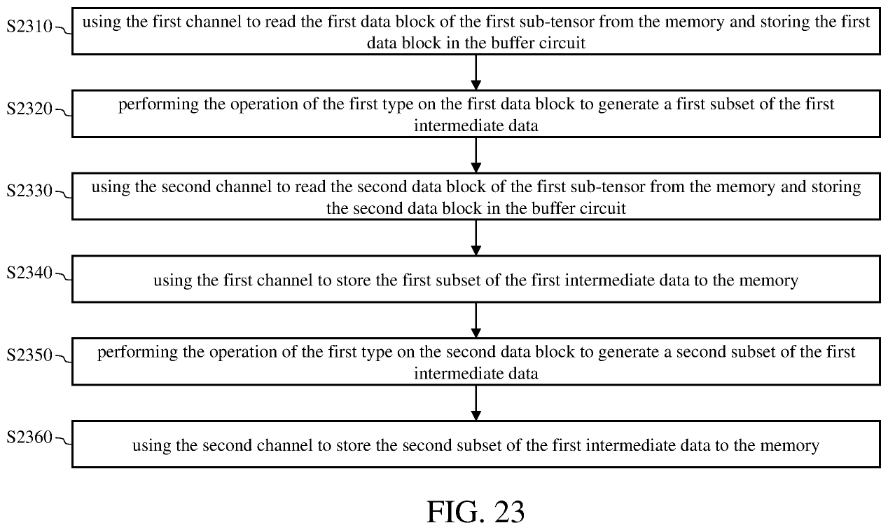

Reference is made to FIG. 23 which is a flowchart of a multi-stage pipeline operation according to an embodiment of the present invention. The flowchart includes the following steps.

Step S2310: The memory management circuit 916 uses the first channel (e.g., channel 916a) to read the first data block (e.g., the data block TS1_i1a) of the first sub-tensor (e.g., the sub-tensor TS1_i1) from the memory 918 and store the first data block in the buffer circuit 914. For example, step S2310 may correspond to the period between the time point T0 and the time point T1 in FIG. 22 (i.e., the “SUB1a load” operation).

Step S2320: The operation circuit 912 performs the operation of the first type (e.g., the subtraction operation) on the first data block (e.g., the data block TS1_i1a) to generate a first subset of the first intermediate data (e.g., a subset of the sub-tensor TS1_o1). For example, step S2320 may correspond to the period between the time point T1 and the time point T2 in FIG. 22 (i.e., the “SUB1a compute” operation).

Step S2330: The memory management circuit 916 uses the second channel (e.g., the channel 916b) to read the second data block (e.g., the data block TS1_i1b) of the first sub-tensor from the memory 918 and store the second data block in the buffer circuit 914. For example, step S2330 may correspond to the period between the time point T1 and the time point T2 in FIG. 22 (i.e., the “SUB1b load” operation). In other words, step S2320 and step S2330 are performed at least partially simultaneously.

Step S2340: The memory management circuit 916 uses the first channel (e.g., the channel 916a) to store the first subset of the first intermediate data (e.g., a part of the sub-tensor TS1_o1) to the memory 918. For example, step S2340 may correspond to the period between the time point T2 and the time point T3 in FIG. 22 (i.e., the “SUB1a store” operation).

Step S2350: The operation circuit 912 performs the operation of the first type (e.g., the subtraction operation) on the second data block (e.g., the data block TS1_i1b) to generate a second subset of the first intermediate data (e.g., a part of the sub-tensor TS1_o1). For example, step S2350 may correspond to the period between the time point T2 and the time point T3 in FIG. 22 (i.e., the “SUB1b compute” operation). In other words, step S2340 and step S2350 are performed at least partially simultaneously.

Step S2360: The memory management circuit 916 uses the second channel (e.g., the channel 916b) to store the second subset of the first intermediate data (e.g., a part of the sub-tensor TS1_o1) to the memory 918. For example, step S2360 may correspond to the period between the time point T3 and the time point T4 in FIG. 22 (i.e., the “SUB1b store” operation).

People having ordinary skill in the art can understand other operations after the time point T4 in FIG. 22 according to the discussion of FIG. 23, so the details are omitted for brevity.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A processing circuit for an artificial intelligence (AI) model, the processing circuit being coupled to an external memory and comprising:
a memory;
a memory management circuit configured to read a tensor from the external memory and store the tensor in the memory; and
an operation circuit configured to:
perform an operation of a first type on a first sub-tensor of the tensor to generate a first intermediate data;
perform the operation of the first type on a second sub-tensor of the tensor to generate a second intermediate data;
perform an operation of a second type on the first intermediate data and the second intermediate data to generate a third intermediate data;
perform the operation of the first type on a third sub-tensor of the tensor to generate a fourth intermediate data; and
perform the operation of the second type on the first intermediate data, the second intermediate data, and the fourth intermediate data to generate a fifth intermediate data.

2. The processing circuit of claim 1, wherein the memory management circuit stores the first intermediate data and the second intermediate data in the memory and deletes the first intermediate data from the memory after the fifth intermediate data is generated.

3. The processing circuit of claim 1, wherein the operation of the first type is one of an addition operation and a subtraction operation, and the operation of the second type is a convolution operation.

4. The processing circuit of claim 1, wherein the first intermediate data, the second intermediate data, and the fourth intermediate data correspond to a same dimension of the tensor.

5. The processing circuit of claim 4, wherein the fourth intermediate data is generated after the third intermediate data is generated.

6. The processing circuit of claim 1 further comprising:
a buffer circuit;
wherein when the operation circuit performs the operation of the first type, the memory management circuit reads at least one subset of kernel parameters from the memory to the buffer circuit, and the operation circuit refers to only the at least one subset of the kernel parameters to perform the operation of the first type;
wherein the operation of the first type is one of a subtraction operation and an addition operation.

7. The processing circuit of claim 1, wherein the first intermediate data, the second intermediate data, and the fourth intermediate data are of a same size.

8. The processing circuit of claim 1, wherein the memory management circuit comprises a first channel and a second channel, and performing the operation of the first type on the first sub-tensor comprises following steps:
(A) using the first channel to read a first data block of the first sub-tensor from the memory;
(B) performing the operation of the first type on the first data block to generate a first subset of the first intermediate data;
(C) using the second channel to read a second data block of the first sub-tensor from the memory;
(D) using the first channel to store the first subset of the first intermediate data to the memory;
(E) performing an operation of the first type on the second data block to generate a second subset of the first intermediate data; and
(F) using the second channel to store the second subset of the first intermediate data to the memory;
wherein step (B) and step (C) are performed at least partially simultaneously, and step (D) and step (E) are performed at least partially simultaneously.

9. A processing circuit for an artificial intelligence (AI) model, the processing circuit being coupled to an external memory, comprising a memory, and performing following operations:
reading a tensor and a plurality of kernel parameters from the external memory and storing the tensor and the kernel parameters in the memory, wherein the tensor includes a first sub-tensor and a second sub-tensor, and the kernel parameters include vector kernel parameters;
performing a first vector operation on the first sub-tensor with reference to a first subset of the vector kernel parameters to generate a first intermediate data; and
performing a second vector operation on the second sub-tensor with reference to a second subset of the vector kernel parameters to generate a second intermediate data;
wherein the first subset of the vector kernel parameters is different from the second subset of the vector kernel parameters.

10. The processing circuit of claim 9, wherein the tensor further comprises a third sub-tensor, and the kernel parameters further comprise convolution kernel parameters for a convolution operation, the processing circuit further performing following operations:
performing the convolution operation on the first intermediate data and the second intermediate data with reference to the convolution kernel parameters to generate a third intermediate data; and
performing a third vector operation on the third sub-tensor with reference to a third subset of the vector kernel parameters to generate a fourth intermediate data after the convolution operation.

11. The processing circuit of claim 10, wherein the convolution operation is a first convolution operation, the processing circuit further performing following operations:
performing a second convolution operation on the first intermediate data, the second intermediate data, and the fourth intermediate data with reference to the convolution kernel parameters.

12. The processing circuit of claim 11, wherein the first intermediate data is stored in the memory, the processing circuit further performing following operations:
deleting the first intermediate data from the memory after the second convolution operation is performed.

13. The processing circuit of claim 9, wherein the first sub-tensor and the second sub-tensor correspond to a same dimension of the tensor.

14. The processing circuit of claim 9, wherein the first vector operation and the second vector operation are one of an addition operation and a subtraction operation.

15. The processing circuit of claim 9, wherein the processing circuit further comprises a memory management circuit, and the memory management circuit comprises a first channel and a second channel, the step of performing the first vector operation on the first sub-tensor to generate the first intermediate data comprising following steps:
(A) using the first channel to read a first data block of the first sub-tensor from the memory;
(B) performing an operation on the first data block to generate a first subset of the first intermediate data;
(C) using the second channel to read a second data block of the first sub-tensor from the memory;
(D) using the first channel to store the first subset of the first intermediate data to the memory;
(E) performing the operation on the second data block to generate a second subset of the first intermediate data; and
(F) using the second channel to store the second subset of the first intermediate data to the memory;
wherein step (B) and step (C) are performed at least partially simultaneously, and step (D) and step (E) are performed at least partially simultaneously.

16. A computation scheduling method for an artificial intelligence (AI) model that comprises a first operator and a second operator, the computation scheduling method comprising:
splitting a tensor into H sub-tensors, wherein H is an integer greater than one;
splitting the first operator into H first sub-operators;
splitting the second operator into H second sub-operators;
determining a dependency relationship among the H first sub-operators and the H second sub-operators;
sorting the H first sub-operators and the H second sub-operators according to the dependency relationship to obtain an operation order; and
determining, according to the operation order, when a processing circuit executing the AI model deletes a target data from a memory included in the processing circuit, the target data being an output data of one of the H first sub-operators and the H second sub-operators.

17. The computation scheduling method of claim 16, wherein the step of determining the dependency relationship among the H first sub-operators and the H second sub-operators comprises:
determining a target sub-operator;
determining a source sub-operator of the target sub-operator, wherein an output of the source sub-operator is an input of the target sub-operator; and
determining that the target sub-operator depends on the source sub-operator.

18. The computation scheduling method of claim 16, wherein the step of sorting the H first sub-operators and the H second sub-operators according to the dependency relationship to obtain the operation order comprises:
(A) determining a target sub-operator;
(B) determining a source sub-operator on which the target sub-operator depends;
(C) adding the source sub-operator to a queue when the source sub-operator does not depend on any sub-operator;
(D) repeating step (B) to step (C) until all of the source sub-operators on which the target sub-operator depends have been added to the queue; and
(E) adding the target sub-operator to the queue.

19. The computation scheduling method of claim 18, wherein the step of sorting the H first sub-operators and the H second sub-operators according to the dependency relationship to obtain the operation order further comprises:
(F) determining an upper-level sub-operator that depends on the target sub-operator;
(G) using the upper-level sub-operator as the target sub-operator and repeating step (B) to step (E); and
(H) repeating step (F) and step (G) until the target sub-operator is a top-level sub-operator.

20. The computation scheduling method of claim 18, wherein the step of determining when to delete the target data from the memory according to the operation order comprises:
determining, according to the queue, a sub-operator that is the last to use the target data, the sub-operator being one of the H first sub-operators and the H second sub-operators;
wherein the target data is deleted after an operation of the sub-operator is completed.
